(19) United States
(12) Patent Application Publication
(10) Pub. No.: US 2023/0410137 A1
(43) Pub. Date: Dec. 21, 2023

(54) METHODS FOR MANAGING VIRTUAL SHOPPING CARTS

(71) Applicant: Shopify Inc., Ottawa (CA)

(72) Inventors: David SCANTLEBURY, Oakville (CA); Gyo-Bin GO, Riverview (CA); Joshua KOOPFERSTOCK, Ottawa (CA); David-James HOUGHTON, Ottawa (CA); Gabriel SECHAN, Jersey City, NJ (US)

(73) Assignee: Shopify Inc., Ottawa (CA)

(21) Appl. No.: 17/880,878

(22) Filed: Aug. 4, 2022

Related U.S. Application Data
(60) Provisional application No. 63/352,431, filed on Jun. 15, 2022.

(51) Int. Cl. G06Q 30/02; G06Q 30/06

(52) U.S. Cl. CPC G06Q 30/0211; G06Q 30/0633

(57) ABSTRACT

A computer-implemented method is disclosed. The method includes: obtaining cart content data of a virtual shopping cart including indications of product items currently contained in the virtual shopping cart; determining a first set of discounts that are applicable to at least one of the product items; determining an optimal allocation of discounts of the first set among the product items; and outputting the optimal allocation of the discounts. Related computer systems, computer-readable media, and computer program products are also disclosed.

### CROSS-REFERENCE TO RELATED APPLICATION

The present application claims priority to U.S. Provisional Application No. 63/352,431 entitled “Methods for Managing Virtual Shopping Carts”, filed on Jun. 15, 2022, the contents of which are herein incorporated by reference in their entirety.

### TECHNICAL FIELD

The present disclosure relates to e-commerce platforms and, in particular, to methods for managing virtual shopping carts associated with online storefronts on an e-commerce platform.

### BACKGROUND

A virtual shopping cart is software that enables purchase transactions. In particular, a virtual shopping cart is a data container that contains product data of products selected by customers for purchase. A customer can populate a virtual shopping cart by adding products to the cart and proceed to a checkout interface when they are ready to pay for the products. As the contents of a virtual shopping cart are a representation of a customer's intent to purchase the selected products, effective management of cart data may directly affect conversion of purchase intent into sales.

### BRIEF DESCRIPTION OF THE DRAWINGS

Embodiments will be described, by way of example only, with reference to the accompanying figures wherein:

FIG. 1 is a block diagram illustrating a cart manager for a virtual shopping cart associated with an example e-commerce platform;

FIG. 2 shows, in flowchart form, an example method for determining optimal allocation of discounts among products in a virtual shopping cart;

FIG. 3 shows, in flowchart form, another example method for determining optimal allocation of discounts among products in a virtual shopping cart;

FIG. 4 illustrates an example data structure that may be used in determining an optimal allocation of discounts among product items of a virtual shopping cart;

FIG. 5A is a high-level schematic diagram of a computing device;

FIG. 5B shows a simplified organization of software components stored in a memory of the computing device of FIG. 5A;

FIG. 6 is a block diagram illustrating components of an example e-commerce platform; and

FIG. 7 is an example of a home page of an administrator, in accordance with an example embodiment.

Like reference numerals are used in the drawings to denote like elements and features.

### DETAILED DESCRIPTION OF EMBODIMENTS

Effective real-time management of cart data of virtual shopping carts can have a significant impact on conversion of customers' purchase intent into sales. The cart content data of a virtual shopping cart includes product data of products that have been added to the cart. Once products are added to a cart, the product data of the added products may be customized for the individual customer. In particular, certain modifications may be applied to the product data such that information about the added products that is accessed within the cart by the individual customer is different from information for the same products that is accessible by all other customers (for example, on a product listing page). The modifications, i.e., cart customizations, that are applied to the product data may include, for example, discounts on product prices, quantity adjustments, size customizations, and the like.

For products in a virtual shopping cart, there may be multiple modifications that are applicable to the product data. It is desirable to determine, in real-time, optimal allocations of the product data modifications among the products such that cart content data that is presented is favorable to the individual customer. By way of example, the products in a cart may be eligible for certain discounts which may be applicable for reducing the sale prices of the products. By optimizing the combination of discounts for applying to the products of a virtual shopping cart, the customer may be presented with an overall lowest possible cost for the current cart prior to checkout.

In the context of discounts (and more generally, dynamic pricing) for products of a virtual shopping cart, the values of discounts may be recalculated whenever there is a change to the cart (e.g., adding a product to the cart, removing a product, etc.), during a checkout process, etc. The calculations need to be performed in real-time such that customized/modified product data can be presented expeditiously to the customer associated with the cart—delays in presenting product data and changes therein may result in abandoned carts and consequently, loss of sales.

This presents a technical challenge for e-commerce platforms to efficiently determine customized product data for virtual shopping carts. The problem can be computationally complex and may be constrained by requirements of a cart interface to present the product data in real-time or near real-time (i.e., within a defined time period) to the customer. For example, it is desirable for an e-commerce platform (and more specifically, a cart management system) to be able to present customized, or modified, product data for products in a customer's cart on demand (e.g., following changes to the cart, during a shopping session, etc.). Accordingly, it is further desired for e-commerce systems to be efficient in the use of processing and memory resources for determining customized cart data while respecting any time constraints associated with cart interfaces such as, for example, refresh intervals for a shopping cart webpage.

The present application describes solutions for addressing some of the aforementioned technical challenges and limitations associated with e-commerce platforms. In an aspect, a computer-implemented method is disclosed. The method may be implemented by, for example, a computing system associated with an e-commerce platform. The method includes: obtaining cart content data of a virtual shopping cart including indications of product items currently contained in the virtual shopping cart; determining a first set of discounts that are applicable to at least one of the product items; determining an optimal allocation of discounts of the first set among the product items; and outputting the optimal allocation of the discounts.

In some implementations, determining the optimal allocation of the discounts may include: constructing a graph including first nodes representing the product items and second nodes representing discounts that are applicable to the product items, each first node being adjacent to one or more second nodes; determining allocations of the discounts corresponding to traversal paths associated with the graph; and performing comparisons of the allocations of the discounts for identifying the optimal allocation that minimizes overall cost associated with the virtual shopping cart.

In some implementations, determining the allocations of the discounts may include traversing the graph.

In some implementations, the graph may be traversed using recursion.

In some implementations, the traversing the graph may include performing a depth-first search of the graph.

In some implementations, the method may further include: storing, in memory, a current best allocation that is determined based on the traversing the graph; and detecting expiry of a timeout period associated with the traversal, and outputting the optimal allocation of the discounts may include outputting the current best allocation stored in memory at a time of detecting the expiry of the timeout period.

In some implementations, the method may further include: storing, in memory, a current best allocation that is determined based on the traversing the graph; and determining a memory usage limit associated with the traversal, and outputting the optimal allocation of the discounts may include outputting the current best allocation stored in memory at a time of detecting that the memory usage limit has been reached.

In some implementations, the method may further include: determining that a number of discounts of the first set exceeds a defined threshold; and removing one or more discounts from the first set in a deterministic manner.

In some implementations, the method may further include determining a first number of combinable discounts in the first set, wherein the optimal allocation of the discounts is determined in response to determining that the first number is less than a defined threshold.

In some implementations, the method may further include, in response to determining that the first number exceeds the defined threshold: determining the optimal allocation of the discounts based on identifying, for each remaining discount in the first set, a product item to which the discount is applicable for maximizing reduction in overall cost associated with the virtual shopping cart.

In some implementations, outputting the optimal allocation of discounts may include outputting an order of applying the discounts of the first set to the product items.

In some implementations, constructing the graph may include sorting the product items.

In some implementations, the sorting of product items may order the product items based on the number of discounts applicable to the product items.

In some implementations, the optimal allocation of discounts of the first set may be determined iteratively based on determining a set of all discount combinations that are applicable to the product items.

In another aspect, the present application discloses a computing system. The computing system includes a processor and a memory coupled to the processor. The memory stores computer-executable instructions that, when executed by the processor, configure the processor to: obtain cart content data of a virtual shopping cart including indications of product items currently contained in the virtual shopping cart; determine a first set of discounts that are applicable to at least one of the product items; determine an optimal allocation of discounts of the first set among the product items; and output the optimal allocation of the discounts.

In another aspect, the present application discloses a non-transitory, computer-readable medium storing computer-executable instructions that, when executed by a processor, are to cause the processor to carry out at least some of the operations of a method described herein.

In another aspect, the present application discloses a computing system. The computing system includes a processor and a memory coupled to the processor. The memory stores computer-executable instructions that, when executed by the processor, configure the processor to carry out at least some of the operations of a method described herein.

In another aspect, the present application discloses a computer program product. The computer program product includes instructions which, when the program is executed by a computer, are to cause the computer to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “product data” refers generally to data associated with products that are offered for sale on an e-commerce platform. The product data for a product may include, without limitation, product specification, product category, manufacturer information, pricing details, stock availability, inventory location(s), expected delivery time, shipping rates, and tax and tariff information. While some product data may include static information (e.g., manufacturer name, product dimensions, etc.), other product data may be modified by a merchant on the e-commerce platform. For example, the offer price of a product may be varied by the merchant at any time. In particular, the merchant may set the product's offer price to a specific value and update said offer price as desired. Once an order is placed for the product at a certain price by a customer, the merchant commits to pricing; that is, the product price may not be changed for the placed order. Product data that a merchant may control (e.g., change, update, etc.) will be referred to as variable product data. Specifically, variable product data refers to product data that may be changed automatically or at the discretion of the merchant offering the product.

In the present application, the term “e-commerce platform” refers generally to computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and any associated payment requests, via an e-commerce platform, and the e-commerce platform may be equipped with transaction/payment processing components or delegate such processing activities to one or more third-party services. An e-commerce platform may be extensible by connecting one or more additional sales channels representing platforms where products can be sold. In particular, the sales channels may themselves be e-commerce platforms, such as Facebook Shops™, Amazon™, etc.

### Virtual Shopping Carts and Checkout Processes

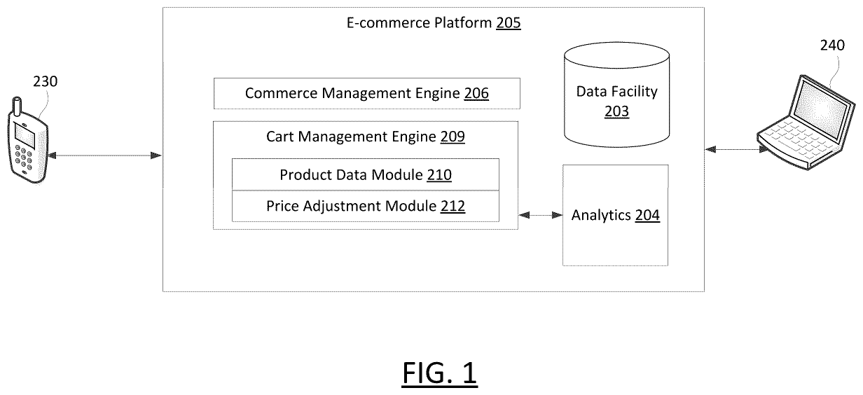

Reference is first made to FIG. 1, which illustrates an example embodiment of an e-commerce platform 205 that implements a commerce management engine 206. The customer devices 230 and the merchant system 240 may be communicably connected to the e-commerce platform 205. In at least some embodiments, the customer devices 230 and the merchant system 240 may be associated with accounts of the e-commerce platform 105. Specifically, the customer devices 230 and the merchant system 240 may be associated with entities (e.g., individuals) that have accounts in connection with the e-commerce platform 205. For example, one or more customer devices 230 and merchant system 240 may be associated with customers (e.g., customers having e-commerce accounts) or merchants having one or more online stores in the e-commerce platform 205.

The e-commerce platform 205 includes a commerce management engine 206, a cart management engine 209, a data facility 203, and a data store 204 for product-related analytics. The commerce management engine 206 may be configured to handle various operations in connection with e-commerce accounts that are associated with the e-commerce platform 205. For example, the commerce management engine 206 may be configured to retrieve e-commerce account information for various entities (e.g., merchants, customers, etc.) and historical account data, such as transaction events data, browsing history data, and the like, for selected e-commerce accounts. In particular, the commerce management engine 206 may obtain account information for e-commerce accounts of customers and/or merchants associated with the e-commerce platform 205.

The functionality described herein may be used in commerce to provide improved customer or buyer experiences. The e-commerce platform 205 could implement the functionality for any of a variety of different applications, examples of which are described herein. In some embodiments, one or more applications that are associated with the e-commerce platform 205 may provide an engine that implements the functionality described herein to make it available to customers and/or to merchants. Furthermore, in some embodiments, the cart management engine 209 provides/includes that engine. The location of the cart management engine 209 may be implementation specific. In some implementations, the cart management engine 209 may be provided at least in part by an e-commerce platform, either as a core function of the e-commerce platform or as an application or service supported by or communicating with the e-commerce platform. Alternatively, the cart management engine 209 may be implemented as a stand-alone service to clients such as a customer device or a merchant device.

The cart management engine 209 manages virtual shopping carts that are accessible via the e-commerce platform 205. Specifically, the cart management engine 209 manages cart content data of virtual shopping carts associated with one or more online storefronts on the e-commerce platform 205. The cart management engine 209 may implement processing of customers' cart-related activities as well as online checkouts. In at least some embodiments, the cart management engine 209 is configured to determine product information for presenting within a virtual shopping cart to an individual customer. In particular, the cart management engine 209 may determine modifications (e.g., price discounts, etc.) to product data of products in a cart. The modified product information of the products in the cart is presented only to the customer(s) associated with the cart, and may be distinct from product information for the same products that is accessible by all other customers of the products.

As shown in FIG. 1, the cart management engine 209 may include and/or implement a product data module 210 and a price adjustment module 212. The product data module 210 may access, edit, or otherwise handle product information of products that are added to a virtual shopping cart. The price adjustment module 212 is configured to, among other functions, determine discounts on prices of products in a cart. The price adjustment module 212 obtains information regarding discounts that are available to be applied to the products. In some embodiments, the price adjustment module 212 may implement various algorithms for determining discounts that can be automatically applied to a current cart. Specifically, the price adjustment module 212 may determine optimal discounts, or combinations of discounts, for applying to the products in a cart. The cart management engine 209 may coordinate with at least the product data module 210 and the price adjustment module 212 in setting product information to present to an individual customer associated with a virtual shopping cart.

An “optimal” combination of discounts refers to allocations of discounts to product items of a cart that results in a lowest overall cost for the cart. The optimization problem for discount allocation arises in the context of merchant-defined constraints on how and when discounts may be applied to products. In particular, an optimal combination of discounts for a cart may result in a lowest overall cost for the cart that is possible while respecting any limits associated with the discounts for the products of the cart.

The data facility 203 may store data collected by the e-commerce platform 205 based on the interaction of merchants and customers with the e-commerce platform 205. For example, merchants provide data through their online sales activity. Examples of merchant data for a merchant include, without limitation, merchant identifying information, product data for products offered for sale, online store settings, geographical regions of sales activity, historical sales data, and inventory locations. Customer data, or data which is based on the interaction of customers and prospective purchasers with the e-commerce platform 205, may also be collected and stored in the data facility 203. Such customer data is obtained on the basis of inputs received via customer devices associated with the customers and/or prospective purchasers. By way of example, historical transaction events data including details of purchase transaction events by customers on the e-commerce platform 205 may be recorded and such transaction events data may be considered customer data. Such transaction events data may indicate product identifiers, date/time of purchase, final sale price, purchaser information (including geographical region of customer), and payment method details, among others. Other data vis-à-vis the use of e-commerce platform 205 by merchants and customers (or prospective purchasers) may be collected and stored in the data facility 203.

The data facility 203 may include customer preference data for customers of the e-commerce platform 205. For example, the data facility 203 may store account information, order history, browsing history, and the like, for each customer having an account associated with the e-commerce platform 205. The data facility 203 may additionally store, for a plurality of e-commerce accounts, wish list data and cart content data for one or more virtual shopping carts.

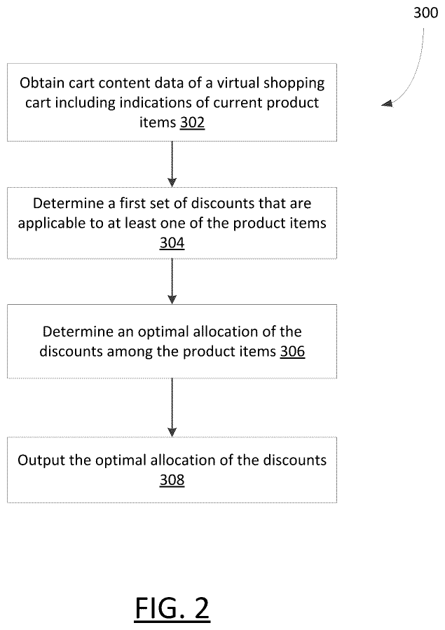

Reference is now made to FIG. 2, which shows, in flowchart form, an example method 300 for determining optimal allocation of discounts among products in a virtual shopping cart. The method 300 may be performed by a computing system that implements processing of cart content data, such as the cart management engine 209 of FIG. 1. As detailed above, the cart management engine 209 may be a service that is provided within or external to an e-commerce platform. The cart management engine 209 may generate control instructions for transmission to customer and/or merchant devices, in accordance with the method 300. The method 300 may be performed in response to a user request for a webpage, such as a product page. The method 300 may be performed each time an item or discount is added to (or removed from) a virtual shopping cart. Examples of a user include a customer, a merchant, or a script.

The following description of method 300 and the associated techniques for optimizing discount combinations relates to the specific case of each product item in a virtual shopping cart being limited to a single discount. Each discount in a combination of discounts may apply to one or more product items in a cart, but each product item may only have a single discount applied thereto. According to method 300, for each discount, a list of the product items that the discount applies to and the associated price reductions for those product items may be determined. The method may then be used to identify “optimal” combinations of discounts based on the restriction that each product item in a cart may only have a single discount applied thereto. It will be understood that the disclosed techniques can be generalized or extended to the case of multiple discounts applying to a single product item and a single discount applying to multiple different items.

In operation 302, the cart management engine obtains cart content data of a virtual shopping cart. The cart content data includes indications of product items that are currently contained in the virtual shopping cart. In at least some embodiments, the cart content data includes product data associated with the product items. For example, the cart content data may indicate, for each product item in the cart: a product identifier, a price of the product item, a customer-selected quantity of the product item, product description, a date and time at which the product was added to the cart, and the like.

In operation 304, the cart management engine determines a first set of discounts that are applicable to at least one of the product items. A discount represents one or more price reduction rules that can be applied to the price of a product item. The price reduction rule associated with a discount may be expressed in terms of percentage, thresholds, fixed amounts, and the like. The first set may include various different types of discounts, such as merchandise discounts, delivery discounts, order discounts, and the like. For obtaining applicable discounts data, the cart management engine may query a third-party service, for example, via requests to an application programming interface (API) associated with the service. The API requests (or other form of query) may be generated by the cart management engine and transmitted over a computer network to the third-party service. Additionally, or alternatively, the cart management engine may access discounts data that is stored in a data storage or database.

In operation 306, the cart management engine determines an optimal allocation of discounts of the first set among the product items. In accordance with embodiments of the present application, the optimal allocation of the discounts is determined based on representing product items and discounts data using a graph data structure. The cart management engine constructs a graph that includes first nodes representing the product items and second nodes representing discounts that are applicable to the product items. The graph is constructed such that each first node is adjacent to one or more second nodes that represent applicable discounts for the product item associated with the first node. The cart management engine determines allocations of the discounts corresponding to traversal paths associated with the graph, and performs comparisons of the allocations of the discounts for identifying the optimal allocation that minimizes overall cost associated with the cart.

When constructing the graph, the cart management engine may sort the product items of the cart. Specifically, the sorting may order the product items based on the number of discounts that are applicable to the product items. For example, such a sort may be performed prior to conducting a search of the graph. Sorting the cart input into the graph data structure can be important as it may tend to allow a search for optimal discount application (e.g., using the graph traversal method discussed herein) to achieve more favourable (and, potentially, optimal allocations) earlier in the search process. Additionally, sorting may provide determinism in cases where the algorithm exits before the exhaustive search is completed. For example, sorting may cause the algorithm to produce consistent results even when such an aborted search only discovers a local rather than a global optimum (e.g., because the search generally progresses in a same or similar manner across subsequent runs of the algorithm). Additionally, or alternatively, while an optimal allocation may only be guaranteed by completing the exhaustive search, the inventors have found experimentally that sorting can, in many real-world example cases, improve the accuracy of incomplete results/cause the algorithm to be more likely to discover a global optimum as compared to a graph search-based implemented with a search. More broadly, as already alluded to, the determinism offered by a graph-based search, especially when coupled with a sort, may have the desirable property that subsequent runs of the algorithm produce consistent results even with slight changes to the input set (e.g., new items added to the cart). In particular, it is noted that it is generally desirable to avoid results that vary across runs (even slightly) as such variation may lead to the impression of oscillating, or “flapping”, results such as may lead a viewer of the output across those runs to perceive a problem or inaccuracy in the output. Such a perception, in turn, could drive a buyer to abandon their cart and/or could cause them to contact a merchant for support.

In at least some embodiments, the determining the allocations of the discounts includes traversing the graph. The traversing the graph may include performing a search of the graph, such as a depth-first search, a breadth-first search, etc. In particular, a graph search of some form may be performed—while recursion is an example of an implementation choice for the graph search, recursion itself is not strictly necessary. An example of a recursive implementation, by the cart management engine, for determining the optimal allocation of a cart is as follows:
Build a list of discounts for each line-item (e.g., added product, shipping, etc.).
Apply discounts to line-items that have only one possible discount combination and remove those discounts from an input set of line-items.
For each remaining disputed line-item, ordered by the number of possible discounts (highest first):
   Recursively build a list of all the line-items touched by any of the discounts on the current line-item, and of any line-items referenced by discounts on those. On completion, this will contain the minimum set of lines that must be searched together.
   (1) For each valid discount combination for the current line:
      (a) Apply the discount combination to a copy of the data set and remove any lines that are now fully allocated.
      If no more lines remain and the total amount saved by the allocated lines is better than that achieved on a prior recursion, update the current ‘best possible’ discount application set.
      Otherwise, recurse back to (1) to process the remaining lines.
   Apply the best possible discount application set and remove the lines from the disputed line-item list.

The cart management engine is configured to ensure determinism across runs of the algorithm(s) that are implemented for determining an optimal allocation of discounts for the product items of a cart. The disclosed techniques for determining optimal discounts for the product items are designed to yield consistent outputs of discounted prices for the product items when the cart is accessed by a customer at different times. In particular, for a defined set of product items in a cart, the optimal allocation of discounts should be the same regardless of when the cart is accessed (i.e., at any point before checkout). In some embodiments, the product items having the same number of applicable discounts may be sorted by one or more criteria such as, for example, maximum possible price reduction (e.g., highest first), order in cart (e.g., chronological order of cart add), and the like.

In some embodiments, the optimal allocation of discounts of the first set may be determined iteratively, rather than by using recursion, based on determining a set of all discount combinations that are applicable to the product items in the cart.

The graph-based technique for determining the optimal allocation of discounts may account for runtime and/or memory usage considerations. In particular, the technique may be designed to balance accuracy of the optimal solution with resource and time cost associated with the technique. For example, the cart management engine may store, in memory, and maintain a current best allocation of discounts that is determined during traversal of the graph. The current best allocation represents a candidate for the optimal allocation. Specifically, the current best allocation at a defined point in the graph traversal represents the best allocation of discounts that is determined up to that point by the algorithm. Upon detecting expiry of a timeout period (i.e., a defined runtime threshold) associated with the traversal, the cart management engine may be configured to output the current best allocation that is stored in memory at the time of detecting the expiry of the timeout period. As another example, the cart management engine may determine a memory usage limit associated with the traversal. When outputting the optimal solution, the cart management engine may be configured to output the current best allocation that is stored in memory at the time of detecting that the memory usage limit has been reached. The technique disclosed in the present application represents a more efficient solution than, for example, a brute force or naïve approach to solving for discount allocations in terms of memory and processing resources. Moreover, the disclosed technique may output solutions even for worst-case scenarios, e.g., complex combinations of discounts, large carts, etc., despite memory and/or processor constraints.

Other techniques, such as limiting the number of applicable discounts, may be employed to ensure that the optimizing does not cause an exponential increase in the number of possible solutions to the extent that an unreasonable amount of time and/or memory is required. For example, where the number of discounts exceeds a defined threshold, one or more of the discounts may be removed from the first set in a deterministic manner. The discounts may be removed proportionally from each of the discount types to prevent an excessive number of discounts of one type from unfairly limiting others. If performance analysis shows that time or further memory constraints are required, those may be added with the following changes:
Group line-items into independent sets of lines that are associated via Discounts, such that each line is in only one set. This is effectively performing step (a) above repeatedly to generate each of the line sets that need to be solved for.
Generate an initial discount application for each set by recursively processing the line-items using the highest value discount combination at each step. This implements an initial depth-first search down a single branch to find an initial possible discount combination.
Progressively improve the results using a breadth-first search. At each step, pick a set and continue the recursion until the next fully complete result set is reached and can be evaluated against its current best allocation. The next set to process should be selected using a priority queue ordered on which set has the lowest potential discounted price when expressed as a percentage of its total line-item value (this concept is supported by the disclosure of the related provisional application). We can experiment with different heuristics here to see what gives the best result

In operation 308, the cart management engine outputs a best approximation of an optimal allocation of the discounts found so far. For example, the optimal allocation of the discounts may be displayed in a user interface associated with the virtual shopping cart. That is, the optimal allocation may be displayed to customers accessing their own carts. In some embodiments, the optimal allocation of the discounts may be automatically applied to the prices of the product items and the discounted prices may be shown in the user interface of the cart.

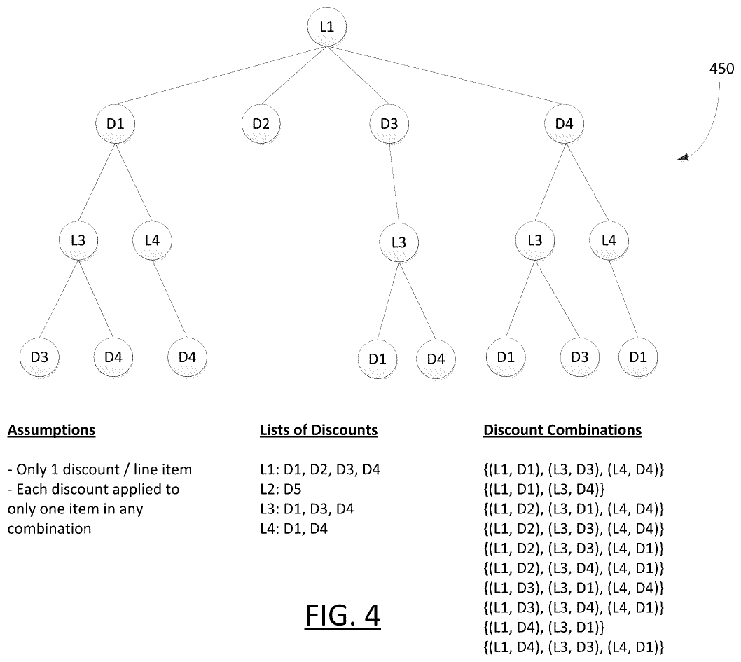

FIG. 4 which illustrates an example graph data structure that may be used in determining an optimal allocation of discounts among product items of a virtual shopping cart. The graph includes nodes L1-L5 representing individual products, i.e., line-items, of a cart and a set of discounts D1-D5 that are applicable to the line-items. An optimal allocation of the discounts D1-D5 to the line-items L1-L5 may be determined based on graph traversal of the graph 450.

As shown in FIG. 4, L2 has only a single discount (D5) that may be applied, and so D5 is not included in the graph construction. The remaining line-items, i.e., L1, L3 and L4, are ordered by the number of possible discounts (highest first): L1, L3 and L4. The optimizing technique involves building a list of all the line-items touched by any of the discounts applicable to the current line-item and of any line-items referenced by discounts on those. Each line-item is represented by a node and each discount applicable on the line-item is represented as an adjacent node. For each valid discount combination for the current line, the discount combination is applied to a copy of the data set and any lines that are now fully allocated are removed. If no more lines remain and the total amount saved by the allocated lines is better than that achieved on a previous recursion, a current best allocation of discounts is updated (e.g., in memory). Otherwise, the technique proceeds to further search the remaining lines.

In the example of FIG. 4, a traversal of the graph along a path that includes L1, D1, L3, D3 corresponds to applying discount D1 to L1 and discount D3 to L3. As L1 and L3 are fully allocated, an optimal solution for L4 can be determined, based on traversal of a smaller subgraph of graph 450. If on a subsequent path (L1, D3, L3, D3), the amount saved by the discounts on L1 and L3 is greater than previously stored amounts, the current best allocation is updated and an optimal solution for the unallocated L4 is determined.

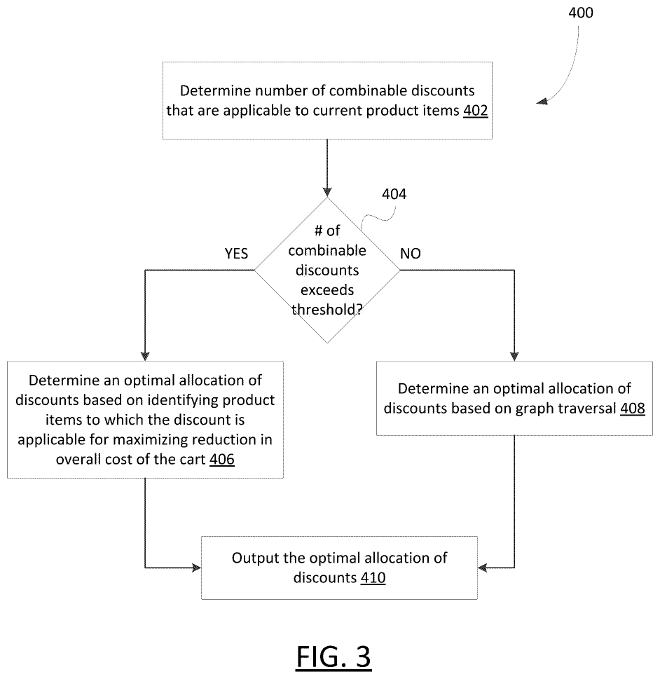

Reference is made to FIG. 3, which shows, in flowchart form, another example method 400 for determining optimal allocation of discounts among products in a virtual shopping cart. The method 400 may be performed by a computing system that implements processing of cart content data, such as the cart management engine 209 of FIG. 1. As detailed above, the cart management engine may be a service that is provided within or external to an e-commerce platform. The cart management engine may generate control instructions for transmission to customer and/or merchant devices, in accordance with the method 400. The operations of method 400 may be performed in addition to, or as alternatives of, one or more operations of method 300. The method 400 represents an implementation of an example heuristic for determining when to use a graph traversal-based solution for optimizing discount allocation and when to use a simpler, non-recursive algorithm. Other example heuristics may be used, either alone or in combination, for discriminating between different approaches for finding an optimal solution to the allocation of discounts to cart items. For example, multiple heuristics may be employed and used with a defined scoring scheme in identifying a suitable approach to finding an optimum for a given cart.

In operation 402, the cart management engine determines a number of combinable discounts that are applicable to the current product items in a cart. A combinable discount refers to a discount which may be applied together, or “overlap”, with a different discount for a same line-item (e.g., product item) of a cart. This number of combinable discounts may be used as a proxy for complexity of the associated graph generation and traversal in determining an optimal allocation of discounts for the cart.

In operation 404, the cart management engine compares the number of combinable discounts to a defined threshold. If the number of combinable discounts exceeds the threshold, the cart management engine determines an optimal allocation of the discounts among the current product items based on a simplified, non-recursive algorithm, in operation 406. Specifically, the cart management engine determines the optimal allocation based on identifying, for each remaining discount in the set of discounts for the current product items, a product item to which the discount is applicable for maximizing reduction in overall cost associated with the cart. Discounts would be re-evaluated after each application to take account of changes to the cart. Those that cannot be applied because all line-items are already fully allocated would be discarded.

On the other hand, if the number of combinable discounts is less than the threshold, the cart management engine determines an optimal allocation of discounts based on a graph traversal solution, in operation 408. In particular, the optimal allocation may be determined in accordance with the techniques described with reference to FIG. 2. The optimal allocation of discounts is then outputted by the cart management engine, in operation 410. When the simplified solution is employed (operation 406), the cart management engine outputs an order of applying the discounts to the product items as part of outputting the optimal allocation of the discounts.

The methods 300 and 400 may be run independently each time they are performed with only a set of cart items and discounts as input or they may cache results or other information (e.g., state) from previous runs. In some cases, resulting optimal allocation may be stored and if the exact same cart input is queried, the cached results may be returned. In other cases, the optimal allocation isn't stored, but an indication of whether the recursive method 300 was run to completion or timed out or ran out of memory. This indicator may be an additional input to operation 404 deciding which method to use. Any cached results or indicators will be removed after a timer. There are distributed system resource allocation advantages to running the methods 300 or 400 independently each time the cart is processed. The methods 300 and 400 are carefully designed to provide deterministic results when run on the same or substantially similar input of carts.

Further detail of example embodiments of the subject-matter of the present application is provided in the materials included in Appendix A—“Extensible Discounts Tech Design” below.

In any of the above-described example methods or processes it will be understood that certain operations described as occurring in sequence may be implemented in a different sequence or carried out in parallel without impacting the overall functioning of the method or process.

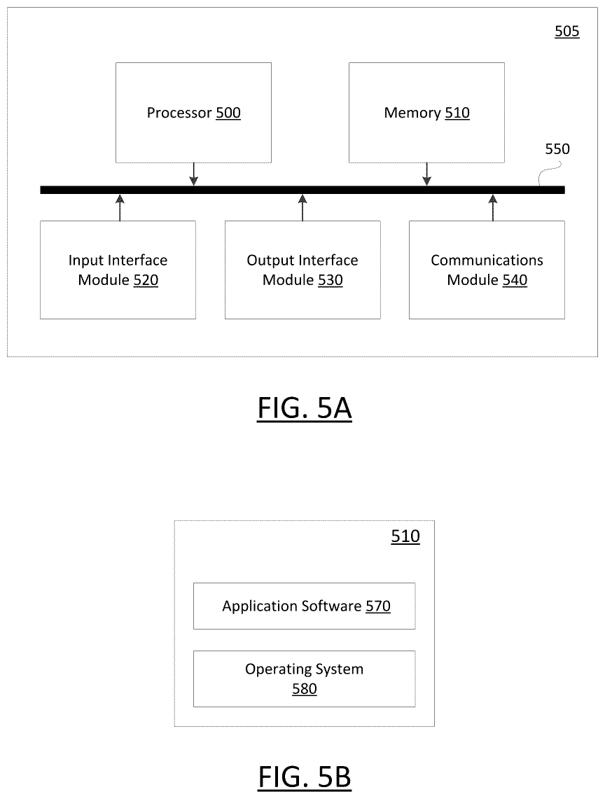

Many of the above-described methods may be implemented by way of suitably-programmed computing device. FIG. 5A is a high-level operation diagram of an example computing device 505. The example computing device 505 includes a variety of modules. For example, as illustrated, the example computing device 505, may include a processor 500, a memory 510, an input interface module 520, an output interface module 530, and a communications module 540. As illustrated, the foregoing example modules of the example computing device 505 are in communication over a bus 550.

The processor 500 is a hardware processor. The processor 500 may, for example, be one or more ARM, Intel x86, PowerPC processors or the like.

The memory 510 allows data to be stored and retrieved. The memory 510 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 505.

The input interface module 520 allows the example computing device 505 to receive input signals. Input signals may, for example, correspond to input received from a user. The input interface module 520 may serve to interconnect the example computing device 505 with one or more input devices. Input signals may be received from input devices by the input interface module 520. Input devices may, for example, include one or more of a touchscreen input, keyboard, trackball or the like. In some embodiments, all or a portion of the input interface module 520 may be integrated with an input device. For example, the input interface module 520 may be integrated with one of the aforementioned example input devices.

The output interface module 530 allows the example computing device 505 to provide output signals. Some output signals may, for example, allow provision of output to a user. The output interface module 530 may serve to interconnect the example computing device 505 with one or more output devices. Output signals may be sent to output devices by output interface module 530. Output devices may include, for example, a display screen such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers. In some embodiments, all or a portion of the output interface module 530 may be integrated with an output device. For example, the output interface module 530 may be integrated with one of the aforementioned example output devices.

The communications module 540 allows the example computing device 505 to communicate with other electronic devices and/or various communications networks. For example, the communications module 540 may allow the example computing device 505 to send or receive communications signals. Communications signals may be sent or received according to one or more protocols or according to one or more standards. For example, the communications module 540 may allow the example computing device 505 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 540 may allow the example computing device 505 to communicate using near-field communication (NFC), via Wi-Fi™, using Bluetooth™ or via some combination of one or more networks or protocols. Contactless payments may be made using NFC. In some embodiments, all or a portion of the communications module 540 may be integrated into a component of the example computing device 505. For example, the communications module may be integrated into a communications chipset.

Software comprising instructions is executed by the processor 500 from a computer-readable medium. For example, software may be loaded into random-access memory from persistent storage of memory 510. Additionally, or alternatively, instructions may be executed by the processor 500 directly from read-only memory of memory 510.

FIG. 5B depicts a simplified organization of software components stored in memory 510 of the example computing device 505. As illustrated these software components include an operating system 580 and application software 570.

The operating system 580 is software. The operating system 580 allows the application software 570 to access the processor 500, the memory 510, the input interface module 520, the output interface module 530, and the communications module 540. The operating system 580 may be, for example, Apple iOS™, Google's Android™, Linux™, Microsoft Windows™, or the like.

The application software 570 adapts the example computing device 505, in combination with the operating system 580, to operate as a device performing particular functions.

### Example E-Commerce Platform

Although not required, in some embodiments, the methods disclosed herein may be performed on or in association with an e-commerce platform. An example of an e-commerce platform will now be described.

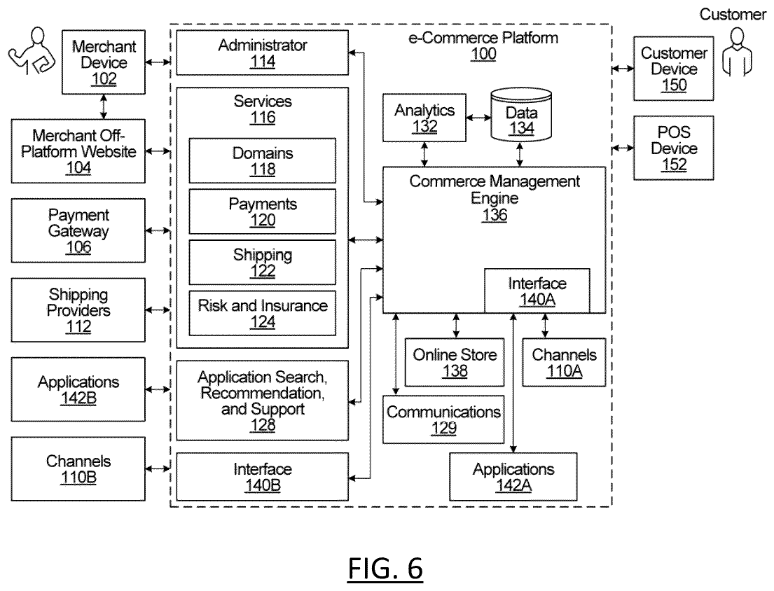

FIG. 6 illustrates an example e-commerce platform 100, according to one embodiment. The e-commerce platform 100 may be exemplary of the e-commerce platform 205 described with reference to FIG. 1. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, additionally or alternatively, be provided by one or more providers/entities.

In the example of FIG. 6, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure, the terms online store and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a transitory memory such as for example, random access memory (RAM), and/or a non-transitory memory such as, for example, a non-transitory computer readable medium such as, for example, persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

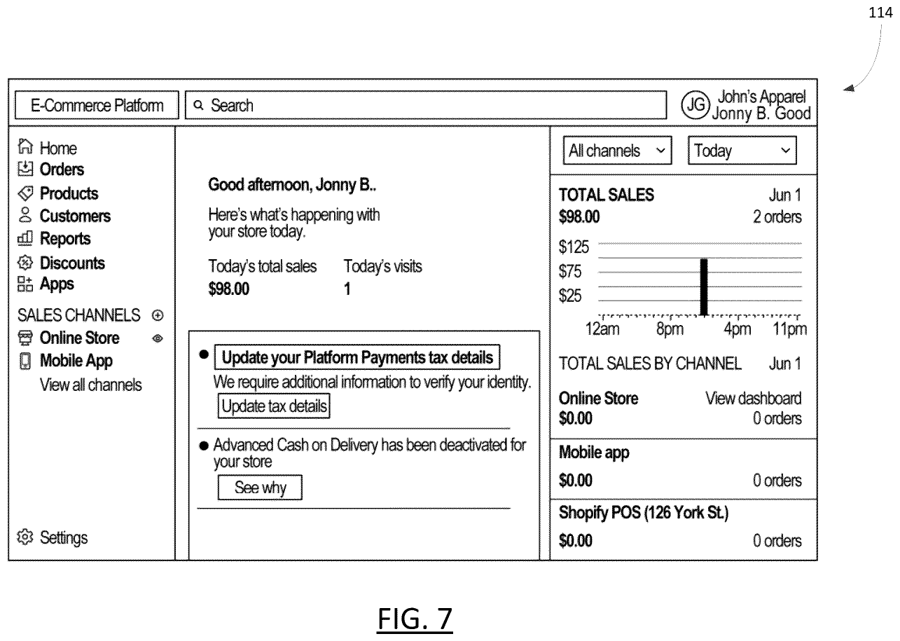

FIG. 7 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 7. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 6, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line-items, where each cart line-item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line-items, shipping line-items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line-items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optimal discs, forms of magnetic storage like hard disks, tapes, drums, cards and other types; processor registers, cache memory, volatile memory, non-volatile memory; optimal storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
detecting a first user action for modifying a virtual shopping cart;
responsive to detecting the first user action, obtaining cart content data of the virtual shopping cart including indications of product items currently contained in the virtual shopping cart;
determining a first set of discounts that are applicable to at least one of the product items;
determining, in real-time, an optimal allocation of discounts of the first set among the product items, wherein determining the optimal allocation comprises:
constructing a graph including a plurality of first nodes representing the product items and second nodes representing discounts that are applicable to the product items, the first nodes being pairwise connected via edges and a respective second node corresponding to a discount that is applicable to both product items associated with the pair;
determining allocations of the discounts corresponding to traversal paths associated with the graph; and
performing comparisons of the allocations of the discounts for identifying the optimal allocation that minimizes overall cost associated with the virtual shopping cart; and
displaying, via a user interface associated with the virtual shopping cart, modified cart content data comprising adjusted product data of the product items based on automatically applying the optimal allocation of the discounts.

2. (canceled)

3. The method of claim 1, wherein determining the optimal allocation of the discounts includes traversing the graph.

4. The method of claim 3, wherein the graph is traversed using recursion.

5. The method of claim 3, wherein the traversing the graph includes performing a depth-first search of the graph.

6. The method of claim 3, further comprising:
storing, in memory, a current best allocation that is determined based on the traversing the graph; and
detecting expiry of a timeout period associated with the traversal,
wherein outputting the optimal allocation of the discounts comprises outputting the current best allocation stored in memory at a time of detecting the expiry of the timeout period.

7. The method of claim 3, further comprising:
storing, in memory, a current best allocation that is determined based on the traversing the graph; and
determining a memory usage limit associated with the traversal,
wherein outputting the optimal allocation of the discounts comprises outputting the current best allocation stored in memory at a time of detecting that the memory usage limit has been reached.

8. The method of claim 1, further comprising:
determining that a number of discounts of the first set exceeds a defined threshold; and
removing one or more discounts from the first set in a deterministic manner.

9. The method of claim 1, further comprising determining a first number of combinable discounts in the first set, wherein the optimal allocation of the discounts is determined in response to determining that the first number is less than a defined threshold.

10. The method of claim 9, further comprising, in response to determining that the first number exceeds the defined threshold:
determining the optimal allocation of the discounts based on identifying, for each remaining discount in the first set, a product item to which the discount is applicable for maximizing reduction in overall cost associated with the virtual shopping cart.

11. The method of claim 10, wherein displaying the modified cart content data comprises determining an order of applying the discounts of the first set to the product items.

12. The method of claim 1, wherein constructing the graph includes sorting the product items.

13. The method of claim 12, wherein the sorting of product items orders the product items based on the number of discounts applicable to the product items.

14. The method of claim 1, wherein the optimal allocation of discounts of the first set is determined iteratively based on determining a set of all discount combinations that are applicable to the product items.

15. A computing system, comprising:
a processor; and
a memory coupled to the processor, the memory storing computer-executable instructions that, when executed by the processor, configure the processor to:
detect a first user action for modifying a virtual shopping cart;
responsive to detecting the first user action, obtain cart content data of a virtual shopping cart including indications of product items currently contained in the virtual shopping cart;
determine a first set of discounts that are applicable to at least one of the product items;
determine, in real-time, an optimal allocation of discounts of the first set among the product items, wherein determining the optimal allocation comprises:
constructing a graph including a plurality of first nodes representing the product items and second nodes representing discounts that are applicable to the product items, the first nodes being pairwise connected via edges and a respective second node corresponding to a discount that is applicable to both product items associated with the pair;
determining allocations of the discounts corresponding to traversal paths associated with the graph; and
performing comparisons of the allocations of the discounts for identifying the optimal allocation that minimizes overall cost associated with the virtual shopping cart; and
display, via a user interface associated with the virtual shopping cart, modified cart content data comprising adjusted product data of the product items based on automatically applying the optimal allocation of the discounts.

16. (canceled)

17. The computing system of claim 15, wherein determining the optimal allocation of the discounts includes traversing the graph.

18. The computing system of claim 17, wherein the graph is traversed using recursion.

19. The computing system of claim 17, wherein the traversing the graph includes performing a depth-first search of the graph.

20. The computing system of claim 17, wherein the instructions, when executed by the processor, further configure the processor to:
store, in memory, a current best allocation that is determined based on the traversing the graph; and
detect expiry of a timeout period associated with the traversal,
wherein outputting the optimal allocation of the discounts comprises outputting the current best allocation stored in memory at a time of detecting the expiry of the timeout period.

21. The computing system of claim 17, wherein the instructions, when executed by the processor, further configure the processor to:
store, in memory, a current best allocation that is determined based on the traversing the graph; and
determine a memory usage limit associated with the traversal,
wherein outputting the optimal allocation of the discounts comprises outputting the current best allocation stored in memory at a time of detecting that the memory usage limit has been reached.

22. The computing system of claim 15, wherein the instructions, when executed, further configure the processor to:
determine that a number of discounts of the first set exceeds a defined threshold; and
remove one or more discounts from the first set in a deterministic manner.

23. The computing system of claim 15, wherein the instructions, when executed by the processor, further configure the processor to determine a first number of combinable discounts in the first set, wherein the optimal allocation of the discounts is determined in response to determining that the first number is less than a defined threshold.

24. The computing system of claim 15, wherein the instructions, when executed by the processor, further configure the processor to, in response to determining that the first number exceeds the defined threshold:
determine the optimal allocation of the discounts based on identifying, for each remaining discount in the first set, a product item to which the discount is applicable for maximizing reduction in overall cost associated with the virtual shopping cart

25. A computer-readable medium storing computer-executable instructions that, when executed by a processor, configure the processor to:
detect a first user action for modifying a virtual shopping cart;
responsive to detecting the first user action, obtain cart content data of a virtual shopping cart including indications of product items currently contained in the virtual shopping cart;
determine a first set of discounts that are applicable to at least one of the product items;
determine, in real-time, an optimal allocation of discounts of the first set among the product items, wherein determining the optimal allocation comprises:
constructing a graph including a plurality of first nodes representing the product items and second nodes representing discounts that are applicable to the product items, the first nodes being pairwise connected via edges and a respective second node corresponding to a discount that is applicable to both product items associated with the pair;
determining allocations of the discounts corresponding to traversal paths associated with the graph; and
performing comparisons of the allocations of the discounts for identifying the optimal allocation that minimizes overall cost associated with the virtual shopping cart; and
display, via a user interface associated with the virtual shopping cart, modified cart content data comprising adjusted product data of the product items based on automatically applying the optimal allocation of the discounts.
